(19) United States
(12) Patent Application Publication
(10) Pub. No.: US 2008/0103262 A1
(43) Pub. Date: May 1, 2008

(54) Method for the Production of Packaging Material Sysems for Technical and Pharmaceutical Individual Dosing

(75) Inventors: Heinz Haschke, Kottingbrunn (AT); Erika Haschke, Kottingbrunn (AT)

Correspondence Address: YOUNG & THOMPSON, 209 Madison Street, Suite 500, ALEXANDRIA, VA, 22314, US

(73) Assignee: Constantia Packaging AG, Wien (AT)

(21) Appl. No.: 11/578,155

(22) PCT Filed: Apr. 14, 2005
(86) PCT No.: PCT/AT05/00130

§ 371 Date: Oct. 11, 2006

(30) Foreign Application Priority Data
Apr. 16, 2004 (AT) A 662/2004

(51) Int. Cl. C08F 8/28

(52) U.S. Cl. 525/384; 525/386

(57) ABSTRACT

A method for the production of packaging material systems for technical and pharmaceutical individual doses uses acid-catalyzed acetalization reaction of polyvinyl alcohol with vinyl alcohol copolymers (PVACL) produced with starch or starch derivatives in conjunction with destructuring agents. In the method, vinyl alcohol copolymers (PVCL) which contain water and which are soluble in cold water are produced either beforehand or after from the films and destructuring agents are added such that the hydrogen bridges between the polymer chains are fully or partially interrupted and that the films of vinyl alcohol copolymers thus prepared are subsequently heated to temperatures below the melting or expansion intervals thereof and are further processed in a sealing process using pressure for the production of a sealing seam for packaging in the form of individual doses.

The invention relates to a process for the production of wrapping and packaging material systems as well as for the covers of packages, in particular for the wrapping of metered dispensing forms for technical and pharmaceutical administration as they produce so-called capsules, in particular soft capsules. The wrapping or packaging material system according to the invention relates to covering materials that consist of (1) vinyl alcohol polymers (PVACL) that are produced by an acid-catalyzed acetalization reaction of polyvinyl alcohol with starch or starch derivatives in combination with (2) destructuring agents, as well as a production process that thus comprises the shaping of such material systems and the tight and direct encasing of the contents to be handled.

1. Prior Art

It is known to package liquid contents or packaging material, such as solutions, emulsions, suspensions, pastes, or solid contents, or contents such as powders, granulates, molded elements such as pellets, tablets, balls, etc.—also briefly mentioned as “contents”—so that each packaging unit corresponds to an exactly metered content dose. In most cases, it is unimportant whether this is a packing or a dispensing form.

According to the definition, “packages” are encasings or “wrappings” that ensure the protection and/or the identification of the contents, whereby, however, such packages are separated from the latter during or before the use of the contents and are used separately or destroyed (see for example, a candy bag).

The wrappings of “dispensing forms,” however, are used or handled together with the contents during direct use and thus have a “common” fate, see, for example, medication capsule. The wrapping of such a—in the special case metered—dispensing form is thus by definition not a package and must therefore have different functional properties from the latter, namely also generally different from a package.

For example, the wrapping of a dispensing form ensures a satisfactory handling, and conversely the additional packaging ensures the protection from environmental influences.

If both packages and dispensing forms are meant, the latter are to be combined under the collective term “packings.”

For example, it is advantageous to package into single doses liquid personal-hygiene and cleaning agents, but also powdery dyes, paste-like bath gels or cosmetic articles, body lotions, perfumes, medications or their preparations, in just the same way as luxury items, agricultural chemicals or fertilizers, which as a whole can also be present as suspensions of solid contents in liquid or paste-like suspending agents, such that the latter, in their application, are not balanced in each case or otherwise must be as measured, but rather are present in exactly the right amounts for the respective purpose and as such are supplied to consumption as a whole. As additional packing materials, in addition receptacles of a known type that consist of material that is inert for the most part, such as bags, cans, cardboard products, plastic and glass flasks, i.a., are suitable.

As such packages or dispensing forms—dosed or not dosed—bags, pouches or capsules are suitable, whereby their shape and form depend on the production processes used for this purpose.

For example, zip-lock bags or tubular bags, or hard or soft capsules, are known.

In addition, as covering materials for such single-portion packings, it is known to use materials that release, or release the contents in a directed fashion, in the respective application by being dissolved in the medium in which they are used.

Cover materials that release their contents into certain organic solvents can thus be used for dispensing forms or for packings of all types, such as also—for the vast majority of previous applications—those that release the contents in aqueous systems. For this purpose, for example, capsules that consist of gelatin, starch or other biopolymers are suitable. For pharmaceutical agents or paintballs, such products have been tested on the market for a long time. However, these cover materials have the drawback that they only dissolve in warm or hot water.

Also, other organic polymers are known that dissolve even in cold water and can be used as packaging materials or covering materials. For example, all-around sealed zip-lock bags that contain liquid and that consist of partially saponified polyvinyl acetate (PVA/PVAc), also briefly referred to as polyvinyl alcohol (PVA), are known.

For this purpose, these polymers or their preparations that are mixed with processing adjuvants, such as softeners, such as glycerol, propylene glycol, water, etc., have other drawbacks, such as relatively high melting points. Thus, in WO-A-92/17382, melting points or melting ranges around 160° C. or around 200° C. are indicated.

In addition, because of the high temperatures to be used when they are melted on in combination with their chemical properties (that is, i.a.: slight capacity for dehydration), PVA materials have the tendency that they tend very quickly toward pyrolysis, and because of their water content, they foam up at elevated temperatures due to the water boiling off and therefore are difficult to bond. Because of these effects in combination with still other disadvantageous properties of such conventional materials, it is described according to WO-A-92/17382 that during bonding, the formation of “pinholes,” i.e., defects in the form of puncture sites, occurs.

For the use of such cover and packaging materials for the production of receptacles, encasings and containers, the packaging films must be sealed, however, in closed containers in each case at least at two sealing seams, which tightly encase the contents, even if they are produced by tube extrusion or optionally are subjected to a deep-drawing process for forming cavities.

In the more advantageous case, this sealing takes place in stable packaging material units, such as bags or capsules, by true bonding in a so-called heat-sealing process with the formation of a true cohesion connection. In this connection, reference is made to the definition of cohesion according to S. Glasstone, Textbook of Physical Chemistry, MacMillan & Co., Ltd. London, page 483, according to which this is the cohesion of two like phases.

In contrast to this, the term “adhesion” is defined only as the adhering of one substance to another substance.

Strictly speaking, heat sealing for producing so-called heat-sealing seams is defined as a process in which certain zones of two or more thermoplastic films are tightly connected to one another by the films in contact with one another being heated up to their melting points and thus making possible a bonding process; see in this respect the teaching according to U.S. Pat. No. 4,154,636.

A typical example of this is the heat sealing of yogurt covers to yogurt cups, in which process the cover that is coated with a thermoplastic heat-sealing wax is pressed by means of ring-shaped heating bowls against the edges of the cup and in this case are heated so high that the heat-sealing wax melts with the cup edge.

Therefore, the polymer phases (films) to be combined must in any case—as also described for heat-sealing processes in the literature (http://plastics.about.com/library/glossary/h/bldef-h2585.htm)—a) be in contact with one another and b) be heated at least to the melting temperature thereof.

Often, however, the term “heat seal,” i.e., “heat sealing” is used for any type of connection of two films under the effect of heat—see the teaching according to WO A1 03/008180 in combination with the teaching from WO A 97/35537—even if in this case this is not a true bonding, i.e., a cohesion connection, but rather only an adhesion, i.e., an adhesion connection.

In contrast to this, in the description of this invention, however, only the purely scientific term “heat seal” or “heat sealing” is to be used.

Naturally, however, the known processes in which the connection of two polymer phases under the action of heat at temperatures above the melting points of the phases that are in contact with one another is achieved by so-called sealing waxes, which were applied as coating, by extrusion coating or co-extrusion, onto the films to be connected, very probably also fall under the exact term of heat sealing. In this case, the heat sealing is carried out by a thin, additional layer between the two films to be connected, which melts on to itself in combination with the temperature used and also causes the two films to be connected to melt. In this case, this is specifically a double bonding, namely the film A with the intermediate layer Z and then again the thus formed composite with its Z side on the second film A. This thus is not an adhesion compound. For example, HDPE films, which are coextruded with an LDPE layer, also fall into this category. Typical of the bonding is therefore the heating to temperatures up to the range of the melts on the contact surfaces to be connected, by which it results in the two phases to be connected flowing into one another—even when the latter are initially different in the above-mentioned example of HDPE and LDPE—and in their mixture. Thus, again, a cohesion connection, and no adhesion connection, is produced.

As an alternative to the previously described true bonding, the adhesion is suitable for the sealing of content units in bags or capsules of the less advantageous process. Less advantageous therefore, since the operation can be performed during adhesion specifically at temperatures below the melting point, but in this case very often so-called “weak seals,” i.e., compounds with weak sealing seam strength, are obtained, see WO A1 093/008180, page 1, line 26. These “weak seals” are apparently strong at first, but after several hours or days—in particular under the action of the contents—the latter open up again, which results in leakages or “sweating” of the packing until the content discharges. When using water-soluble, aqueous packaging materials such as PVA, to this end there is still the problem that adhesion is really relied upon for the production of packing seals; see in this respect the teaching according to WO A1 97/35537 or WO A1 03/008180 A1. Therefore, since the alternative method of the bonding requires the use of temperatures considerably above the boiling point of water, this means that “boiling” of the water that is present there on the sealing seams is unavoidable, such that bubbles or leakage channels through the sealing seams thus are formed.

Less advantageous is also therefore the packing closure by adhesion in comparison to that by bonding, since glued sealing seams generally are not as stable as bonded sealing seams; this therefore since an adhesion connection is produced by the insertion of an adhesive layer, which adhesion connection is also more sensitive relative to the attack by the contents.

These properties of such compounds arise from the general definition of an “adhesion.” In this case, the two polymer phases to be connected (“films”) are associated with other chemical-physical properties by another phase, lying directly between the two phases, that is the “adhesive phase,” which is responsible for the adhesion effect. These other chemical-physical properties primarily relate to the chemical composition that is the nature and the composition of the polymer or the nature and concentration of the softening portion or solvent portion at the time of adhesion and to the miscibility with the other polymer phases that results therefrom, to the viscosity at defined temperature as well as to the melt or softening range. In this case, it is unimportant that the properties or the composition of the adhesive agent phase can change again over the course of time, temperature changes, etc. The pressures necessary for the adhesive process essentially correspond only to those necessary for the flowing of the adhesive phase, or for the prevention of the separation of the two phases to be connected at the time of the pressures necessary to the adhesive process.

During the sealing process of the contents, in addition general problems also develop that depend on the selected process parameters and on the selected packaging material, but also on the contents themselves:

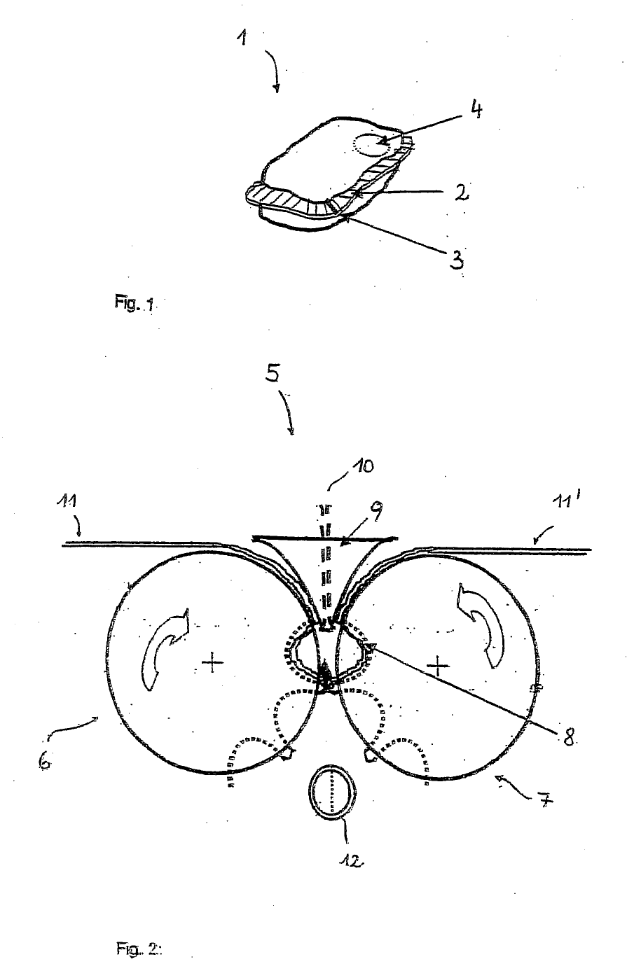

As a sealing process, in the simpler case, a flat sealing process can be selected in which, to ensure a more secure and tight packing of the contents, a relatively wide, generally about 3-5 mm (“extracapsular”) sealing seam—a so-called “Saturn ring”—that connects the bottom and top films together and is located outside of the “capsule” and thus away from the contact area with the contents and that extends around the actual cushion-shaped package (referred to as “pouch” in the English technical literature), is produced as a closure seam—see FIG. 1. For such wide sealing seams, adhesion processes also often suffice if the packings are not exposed to any high mechanical stress or the sealing seam strength does not have to be of excessively long durability.

Such sealing seams are not only unsightly, however, and tend to be sharp-edged; they also prevent the free sliding and thus the capacity for such packages to be shaken. In particular, the separation in the place and time sequence makes possible the process steps, which are necessary for the production of a sealed package or coated-dispensing form, specifically in: a) forming (of a dispensing form or package), via: b) filling, for: c) sealing and d) isolating (punching, cutting out) before adhesives are used.

Moreover, during the packing of liquid contents, such as liquid detergents containing surfactants, it happens again and again that the packaging film zones, which are required for the sealing, are wetted with portions of the contents, such that then the surfactants contained therein act as separating agents and the sealing seam begins to leak at these locations.

It was therefore proposed according to WO A1 03/008180 to wash the contact surfaces to be sealed with a solvent before the sealing or, when using water-soluble packaging materials, with water as a solvent. This process variant produces free rinsing of the contact surfaces to be sealed of possible contaminants by separating agents or—since each separating agent effect is a surface effect—by the dissolving-on of the packaging material and the thus produced dilution of the separating-agent film or possibility of its diffusing away (“sagging”) in the interior of the packaging material, by which the latter is eliminated on the contact surface. It is known that in this way, the action of surface-active substances can be eliminated, in just the same way as oil films are eliminated, if the latter are absorbed into diatomaceous earth or porous dispersion agents. Also and analogously to this, it is known that by such a measure, the sealing connection that is achieved is more secure than without the wetting of the packaging material by a solvent, see WO-A1 03/008180. This applies both for non-aqueous solvent as well as for water as a solvent.

If the potential sealing surfaces are exposed longer to the attack of a solvent, this can finally, after some time, also result in a dissolving-on of the packaging film, by which an adhesive layer is formed on its surface. This would naturally support the heat-sealing process by an additional adhesion to the surface of the sealing surfaces. Since such a dissolving-on of a film by a solvent is, however, a diffusion-controlled process and thus a process in which the penetration depth of the solvent in the film is time-dependent, only a small percentage of the film thickness in an adhesive state is always used, according to this dissolving-on process; conversely, the main residue of the deeper film portion (i.e., the side that faces away from where the solvent is applied) remains unchanged. Therefore, according to WO-A-97/35537 (EP-0889710), mention is made in such conduct of a case of a partial solvation (partial solvation; US-A-2002026771). With the teaching of WO 03/008180 A1, the sealing produced according to such dissolving-on processes or the “enhancement of a heat sealing” has, however, with respect to the type of sealing seam produced, only the nature of a combination that consists of heat sealing and adhesion together and therefore has the nature of the previously mentioned “weak seals,” in particular if the procedure is the same at temperatures below the melting point of the packaging material.

A similar procedure, but with an “opposite” effect, was already proposed in WO-A1-0166082, whereby packaging material that consists of polyvinyl alcohol or of acetals of polyvinyl alcohol for protection against an attack of solvents or the packaging material of dissolved-on contents before the filling with the contents is equipped with a protective layer. This is carried out by immersing in or spraying with “compositions” that consist of PVA or its derivatives in solvents such as water, dimethylformamide, dimethyl sulfoxide, N-methyl-2-pyrrolidone, glycerol, polyethylene glycol fatty acid ester, etc. As a result, a protective apparatus that is suitable for the so-called rotary-die (rotary deep-drawing and sealing) process according to FIG. 2 is to be produced.

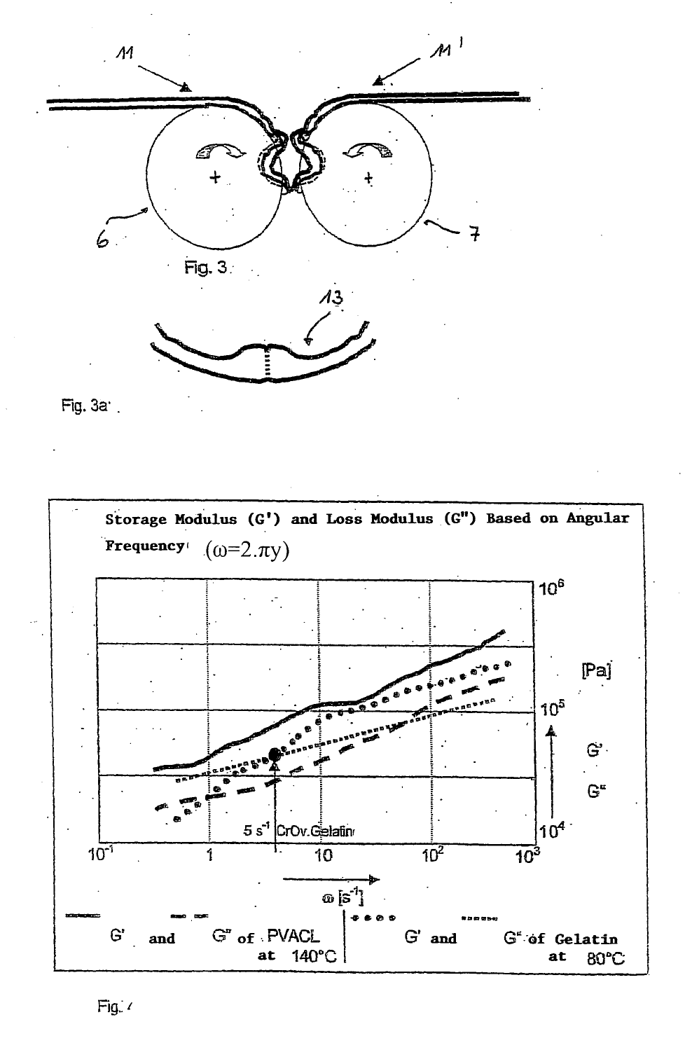

A production rate that is significantly more effective and thus higher—in comparison to the commonly used sealing processes—of an approved and thus more economical and, with respect to the applicability of the obtained single-portion packings, more advantageous sealing process is described in, for example, U.S. Pat. No. 2,288,327, according to which instead of “pouches” (bags), stable and completely filled capsules are made available without a circumferential, wide sealing edge. This so-called rotary-die process, however, is still more sensitive to inadequate bonding, since it does not make possible any wide and extracellular sealing seam—see FIGS. 3 and 3a—and, in addition, since generally only very short exposure times with any sealing adjuvants—such as, for example, the above-mentioned dissolving-on agents—are possible between supplying film and sealing.

In this process, according to which, for example, “paintballs” are produced, two metal cylinders, the so-called section rollers that contain bowls in the shape of half-shells in the capsules to be produced, run in opposite directions to one another. A strip, i.e., a so-called “film” or the “counter-film” of a thermoplastic substance, is fed to each of the two cylinders, whereby at their bowl edges, the cylinders in each case cut out a half-shell of the capsule to be produced from the strips, while the contents are pressed between these two half-shells simultaneously by a pump and during the cutting out and crushing of the thermoplastic on the bowl edges, a sealing is also produced there. In this process, the signal time is in the range of fractions of a second.

The form of the capsules produced according to the rotary-die process is therefore basically different from the “pouches” (bags) produced by the usual sealing of films. Thus, capsules produced according to the rotary-die process do not have any extracapsular sealing edges, but rather the sealing of the films is carried out flush (see FIG. 3a) by squeezing the thermoplastic material, which is between the bowl ridges of the two section rollers.

With these process parameters, the rotary-die process according to the known prior art can be applied only in a limited manner to certain thermoplastics. Such thermoplastics that are suitable for the rotary-die process are: gelatin, thermoplastic starch or carrageenan. The latter are, however, encapsulating materials that are soluble only in warm or hot water.

In acceptance of special limitations with respect to sealing seam strength because of the previously mentioned high-temperature, bubble-forming and low-temperature-weak-seal problems, sealing processes can be applied when switching over to adhesive sealing according to the dissolving-on process with use of the adhesive effects that occur when suitable films, i.e., “suitable” in terms of EP 0 889 710 B1, such as alginate, are partially dissolved-on on their surface, also on high-melting, cold-water-soluble polymers such as PVA, as described in WO-A1-97/35537, or in the combination of the protective layer application process with common solvents (see WO-A1-01/66082). In this respect, this is only an older form of an adhesive process by dissolving-on of the sealing surfaces, as also pointed out in WO 03/008180 A1, which results in the known “weak seals,” i.e., lower sealing seam strengths.

Such “weak seals” are constant sources of defects, in particular in quick-running machine encapsulation processes that allow neither wide, extracellular flat sealing surfaces nor extended dwell times for the penetration of dissolved-on agents in greater film depths, such as the rotary-die process, and thus also the causes for substandard articles with unstable, i.e., weak, sealing seams.

For the formation of permanently tight capsules with stable sealing seams in the rotary-die process, the thermoplastic behavior during filling, like the elongation at rupture of the E-modulus as well as the pressure and temperature dependencies thereof, as well as the sealing behavior of the polymers used as encapsulating materials are, of course, decisive in the temperature range around or usually over or, according to this invention, under the softening point or melting interval thereof to come as close as possible to a sealing in the type of a heat-sealing process with true bonding. According to the prior art, strongly crosslinked polymers, in particular covalent strongly cross-linked polymers, such as, for example, crosslinked phenol resins such as Bakelite®, cannot be bonded at all. Also, polymers or polymer mixtures with softeners with partially crystalline network structure, for example, PE or non-covalent network structure, such as gelatin, carrageenan, can only be bonded if the viscosities that are necessary in this respect are achieved at temperatures below the decomposition temperature.

Water-soluble polymers with a high proportion of water-soluble-making OH groups are also more or less strongly crosslinked (such as PVA) by hydrogen bridges between the OH groups, depending on the chemical structure and OH-group density of the polymer. Whether a true bonding is possible, it can be characterized in the case of thermoplastics by incorporation of so-called storage modulus-(G′)-/loss modulus-(G″) spectra plotted against angular frequency ω=2.π.ν as well as by relaxation enthalpy/relaxation time diagrams. For the rotary-die process, materials are suitable if they are characterized by meeting the following conditions:
a) At temperatures that are slightly, i.e., 1 to 15° C., below their softening point in their storage modulus (G′)-/loss modulus-(G″) spectra in angular frequency range (ω) between 0.1 and 1000 s⁻¹, the thermoplastics have a so-called crossover point (one-point)—the latter is approximately 5 s⁻¹ for gelatin in a temperature range around 80° C. (see FIG. 4), and
b) In the relaxation enthalpy-/relaxation time diagram, the thermoplastics have a relaxation enthalpy maximum at these temperatures that is under 10 s in relaxation times.

Usually, the G′/G″-ω diagrams are always recorded in the vicinity of, but below, the softening point of a thermoplastic, i.e., not above it, since the relaxation measurement usually cannot be carried out in a half-liquid melt. The measurement should also be performed not far below the softening point, i.e., in the hard, cold state, so that the viscosity-relaxation effects and the energy loss effects upon exposure to alternating loads can be noted, which is possible only with difficulty, however, in the hard, cold state.

Polyvinyl alcohol (PVA), which would be an advantageous encapsulating material because of its cold water solubility, has a softening point around 220° C., or if additives (such as certain softeners) are added, in the best case around 160° C. Thus, PVA melts at excessive temperatures to be able to be used in the rotary-die process for the production of true bonded sealing seams. In particular, PVA is not suitable for the encapsulation of aqueous preparations that already begin to boil around 100° C.

In addition, conventional processes, in which cold-water-soluble packaging films that consist of polyvinyl alcohol are produced, have the drawback that according to the scientific studies of EMPA, see H. Schönberger, U. Baumann and W. Keller; Textilveredelung [Textile Finishing] 31 (1996) No. 1/2, pages 19-26, it has become known that polyvinyl alcohol (PVA) cannot always be sufficiently broken down in sewage treatment plants. Rather, because of the high Arrhenius activation energy, which is necessary for the C—C cleavage during breakdown of the PVA molecule, a very pronounced temperature dependency is shown. Therefore, the breakdown of the PVA molecules can proceed fast enough, i.e., according to the requirements of the existing regulations in the European Union for “biodegradable substances,” only during the summer months when the temperature of the waste water in the sedimentation basins is above 12° C.

In this respect, the drawback results that polyvinyl alcohol is a pure synthetic material that cannot be produced from renewable raw materials.

Cold-water-soluble encapsulation materials were to mean a significant technical progress, however, since many contents to be metered individually are used at room temperature or below. Many times, there is also the need that the encapsulating materials be dissolved without residue at room temperature or below.

In this connection, reference can be made to bath preparation capsules, whose encapsulating materials are to leave behind no bands of dirt on the bathtub, as well as paint balls (balls filled with paint) that dissolve without residue in the woods or on playgrounds under the influence of natural moisture and in addition are to be completely biodegradable.

It is therefore the object of this invention to indicate a process of the initially mentioned type, which makes it possible:

To produce capsules that are bubble-free, fully filled and thus dimensionally stable, compact and thus easily handled for single portions and that have a homogeneous, truly bonded sealing edge that runs on the inside, and whereby the encapsulation process is to be carried out efficiently—mechanically, quickly, simply and thus economically. As a result, stable sealed capsules without “weak seals,” i.e., capsules with satisfactory sealing seam strength, actually ale to be made available. The latter have true bonding seams, i.e., no adhesive seams. In addition, a process is to be indicated, as well as the packaging material necessary in this respect is to be made available. The packaging material that is used is to be able to be removed with the waste water or directly in the receiving water consistent with the existing laws on biodegradability, whereby the existing legal and ecological regulations with respect to environmental compatibility are also to be met. This means that the packaging material that is used is to be readily and quickly cold-water-soluble, so that when used or when exposed to rain out of doors, it quickly dissolves without residue. In sewage treatment plants, the packaging material that is used is completely and quickly degraded, whereby according to the most recent regulations, such as the German Packaging Decree (VerpVO of Aug. 21, 998), it is mostly to consist of renewable raw materials.

Surprisingly enough, it was now found that systems that consist of 1) special acetal films, which are produced by the acid-catalyzed acetalization reaction of polyvinyl alcohol with starch or starch derivatives—so-called PVACLs—although they do not have the polymer properties required for bonding ability according to the prior art, such as WO-A-97/35 537, i.e., do not show any crossover point (one-point) in the G′/G″-ω diagram in the angular frequency range of 0.1 to 1000 s⁻¹ at temperatures slightly below their softening point, and that consist of or are in the presence of 2) destructuring agents—that are substances that are suitable to break crosslinking hydrogen bridges into polyols—under certain conditions, namely 3) can be used in a cold-sealing process and result in packages or encapsulations with stable sealing seams. Unlike the heat-sealing process, the cold-sealing process that is applied according to the invention is characterized in that the films to be connected are not heated in contact with one another, whereby the heating is carried out also only to average film temperatures, i.e., below the melting or softening points measured according to conventional processes (this is at approximately 1 atm of pressure and after equilibrium is established at room temperature with relative humidity values of between 45 and 55%). Despite these “uncommon” requirements, the packaging material systems used according to the invention can be used for the production of stable individual packings.

In contrast to the prior art, no heat-sealing process according to the invention is thus carried out, but rather a cold-sealing process is used, in which no adhesive process is carried out so that no adhesion connection is produced. Rather, based on the conditions according to the invention, namely the special properties of the PVACL films in combination with the destructuring agents that are used according to the invention, a true bonding, i.e., a true cohesion connection, is produced.

Although the production of tightly sealed capsules when introducing the contents with separating agent actions, such as surfactant preparations, is especially difficult according to this process in contrast to the sealing process according to the prior art—since the latter is never outside the contact zone with the contents as an extracapsular, wide flat sealing seam according to the geometry of the sealing seam in the rotary-die process, but rather rests directly on the contents—the process according to the invention is also suitable for surfactant contents.

The contrast to the process according to the known prior art is proven, i.a., in that the known corrective measures for free rinsing of the sealing seam by wettings by the contents in the cold-sealing process for the PVACLs without a crossover point without use of the specific conditions according to the invention (destructuring agents) do not function in the production of stable sealing seams. In this connection, reference is made to the improvement of the sealing capacity in the presence of water according to WO-A1-03/008180, see above Comparison Example 4.

Another difference is that simple dissolving-on of PVACL films, for example by wetting with water as a solvent, does not always result in stable sealing seams in the rotary-die process at temperatures that are safe for the contents.

In contrast to the known heat-sealing process, in which the packaging films to be sealed must be a) in contact with one another and b) heated to temperatures above their melting point (melting interval), which is above the boiling point of water, and thus must be bonded, the subject of the invention is thus also a so-called “cold sealing,” in which the risk of boiling the aqueous packaging films or the aqueous contents is avoided. Thus, only a process analogous to heat sealing is used without sealing edges, which is characterized in that the systems according to the invention are produced from special softener-containing acetals and aqueous acetals. This is understood to include vinyl alcohol copolymers (PVACL) produced by the acid-catalyzed acetalization reaction of polyvinyl alcohol with starch or starch derivatives, see EP-A-771 329. A group of PVACLs is selected therefrom, which have quite specific softeners and water contents and which are heated only up to significantly below the usual melting point thereof in the rotary-die process with destructuring agents under certain conditions, namely a cold sealing analogous to the heat sealing without contact with one another, and then are brought into contact with one another without further increase in temperature and are bonded under pressure.

In this case, an effect that acts similarly to the known “regulation of ice” is used by the systems according to the invention that consist of PVACLs in combination with the hydrogen-bridge-breaking destructuring agents in their melt viscosity vs. pressure diagrams having so-called characteristics with negative increase, according to which it results in a reduction of the melt viscosity under pressure and/or the effect of friction forces and thus in a better flow, which has an effect in the rotary-die process that is similar to melting or softening below the usual (i.e., at normal pressure of 1 atm) melting or softening point, by which it results in a true bonding process instead of an adhesion by flowable material pressed out from the interior of the film.

The “cold-sealing process” that is applied according to the invention is thus also distinguished from the so-called “cold-bonding processes” known according to the prior art, as they are used, for example, to glue PVC pipes to PVC pipe sockets, whereby the PVC surface is thus dissolved-on and then added together with a solution of the same plastic, i.e., PVC or a low-molecular variant thereof, coated in a solvent for PVC. In this case, this is thus—despite the name “cold-bonding”—also only a cold-solution-adhesion process.

The designation “considerably below their melting point (melting range)” is to be defined for the conditions according to the invention as an interval of at least 5° C. under the melting or softening point that can be determined by means of DSC. In a preferred embodiment, the surface temperature of the films that are to be connected at the time of the pressing together for sealing and at this site and during the filling with the contents is to be in the range of between 20 to 5° C. below the melting or softening point that can be determined by means of DSC; especially preferred is the range between 5 to 10° C. below the beginning of the melt interval that can be determined by means of DSC.

For example, according to the process according to the invention, a PVACL film, which has a melting range of about 151-166° C. according to the differential-thermoanalysis (DTA or differential thermo-scanning; DSC), can be sealed permanently tightly against a like PVACL film as early as after preheating to a mean film temperature of a maximum of 145° C.

If work is done according to the rotary-die process, in general mean temperatures of the film that is to be thermoformed and sealed, which lie especially considerably below the temperature of the heating segment, thus are reached by the heating of the films fed to the section rollers being carried out primarily only on the heating segment between the two films that are fed separately from one another. Also, here, a) there is no direct contact between the films and the heating segment, since between them an oil is generally used as a lubricant, which acts as a heat transition resistance, and b) the first heat loss occurs during the thermoforming process, i.e., the pressing through of the films into the bowls of the section rollers on the latter even before the sealing, and, in addition, c) an additional cooling is carried out by the sprayed contents even before the sealing on the sides of the film facing one another.

This process in combination with the cold-sealing process according to the invention works especially advantageously in the production of single portions in the form of capsules with galenical preparations that are filled with heat-sensitive medications, such as, for example, suspensions of antibiotics in polyethylene glycols, etc.

The components (1) that are to be used for the systems according to the invention are special acetals that consist of polyvinyl alcohol and starch or starch derivatives (PVACLs) that are produced by acid-catalyzed acetalization of 30-65% by weight of starch or starch derivatives with 70-35% by weight of polyvinyl alcohol, preferably 35-45% by weight of starch with 65-55% by weight of PVA of mixtures of various PVA types, whereby the polyvinyl alcohol component has mean molecular weights (weight average) of between 25,000 and 130,000, preferably between 30,000 and 70,000 and is formed by partial saponification of polyvinyl acetate up to a degree of saponification of between 80 and 92 mol %, preferably between 85 and 90 mol %, and whereby the starch components in the PVACL suitable for the process according to the invention or the packages according to the invention is selected from the group of native potato starch, corn, rice or tapioca starch. The starch derivatives are partially degraded starches, which are reduced to mean molecular weights (weight average; M_{w}) of between 50,000 and 500,000, preferably to M_{w}=150,000 and 300,000 in their molecular weight by oxidative reduction and that contain less than 0.01% by weight of dialdehyde starch. In this case, those that are propoxylated between 5 to 20 mol % (relative to the C₆ units) are preferable. After the acetalization for the production of PVACLs, the acid catalysts that are contained in the reaction mixture are again neutralized. As neutralization agents, all proton acceptors, such as ammonia, aqueous ammonium hydroxide solution, sodium hydroxide solution but also amines, are suitable. A preferred neutralization agent is triethanolamine.

The softeners in the PVACLs to be used according to the invention are glycerol and/or ethylene glycol or propylene glycol, which also still can be used together with so-called co-softeners such as polyglycerol or polyethylene glycols. The proportions of the sums of these softeners and co-softeners are in a range of 10 to 30% by weight relative to the sums of the weights of the PVA and the starch or starch derivative components, preferably in a range of 11 to 20% by weight. The co-softeners can constitute between 0 and 70% by weight, preferably between 0 and 40% by weight, of the sum that consists of softeners and co-softeners.

The water content of the PVACLs to be used according to the invention—determined according to Karl-Fischer or preferably through the drying loss after 24 hours at 105° C.—is between 7 and 25% by weight, preferably between 10 and 20% by weight (relative to the overall PVACL). In this case, the softener and water portions are to be adjusted such that films thereof, which were produced in a preliminary test by extrusion, in a universal rheometer of the Paar-Physics Company with a plate-plate-measuring system in the oscillation mode and after spraying with one of the suitable destructuring agents and 5 seconds of rest time in the relaxation enthalpy-/relaxation time diagram, have a maximum of the relaxation enthalpy at times below 2 seconds, which is easily possible in a preliminary test and measurements on the universal rheometer.

As for the components (2) to be used for the systems according to the invention, the destructuring agents are the substances that are suitable to break cross-linking via hydrogen bridges or to interrupt such networks.

These are thus substances of type A that, even when mixed in with PVACLs or in contact with PVACL films on their surfaces, are able to enter into hydrogen bonds and to replace existing cross-linked hydrogen bridges (“to decouple”), but in this case they are not bifunctional or polyfunctional, so that they themselves are not capable of any network formation but rather only of a simple saturation of a functional group able to form hydrogen bridges, for example an OH group in PVACL, in the polymer. Examples of such “type-A destructuring agents” are so-called montanic acids and/or monovalent alcohols that are produced by esters of montanic acids with ethylene glycol and/or 1,3-butanediol and/or glycerol, substances as they are listed in the Guidelines 93/10/EWG of the Commission of Mar. 15, 1992 as reliable packaging film additives for contact with foods and/or anionic and non-ionic surfactants such as n-dodecyl sulfate, alkylsulfonates, alkylphenol or alkyl alcohol-ethylene oxide adducts, oxidized—preferably low-molecular—polyethylene, in particular monovalent, branched C₁₀-C₁₆-alcohols or ethoxylation products of the latter or their multivalent analogs with 5-20, preferably 5-10 add-on ethoxy groups. Especially preferred are monovalent, so-called GUERBET alcohols. These are branched-chain alcohols, which are produced from fatty alcohols by self-condensation under catalysis by sodium or copper at temperatures around 200° C. and under pressure, as described in EP A 0 970 998 (see commercial product “stenol” of the company Herkommer & Bangerter GmbH & Co. KG).

Destructuring agents can also be those of type B, however, that are so-called “inner destructuring agents,” i.e., those that produce the object of the decoupling of network-forming hydrogen bridges, such that they react chemically with the polymer molecule “to be decrosslinked” and thus adhere to a portion of the hydrogen-bridge-forming functional groups thereof and in this way result in a partial decrosslinking by their saturation and/or by the steric effects that they produce with respect to expansion of the polymer molecule cannula. In this case, this “adhesion” by chemical reaction can take place as early as during the production of PVACLs in the reaction extrusion or else also then under circumstances even in the cold state by secondary reaction of the destructuring agent mixed into the PVACL mass. Examples of such “type-B destructuring agents” are aldehydes or ketones such as benzaldehyde or natural substances, such as poly-, oligo- or monosaccharides, pectins, hyaluronic acid, etc., or their degradation products, which contain carbonyl groups or presumptive carbonyl groups and which can react with the latter with the free OH groups of the vinyl alcohol areas of the PVACL polymer molecules with semiacetal formation.

For the implementation of the systems according to the invention, the two components, which are 1) PVACL and 2) destructuring agents, can be made available both as a homogeneous mixture in the form of combination systems with one another or simply in contact with one another or reacted in the case of type-B-destructuring agents.

In a special embodiment for the production of combination systems, the destructuring agents, i.e., the components (2), are already introduced into the PVACLs directly before use of the systems. This is carried out either in a preferred production process variant directly, i.e., “as is” (i.e., untreated, undiluted), by kneading in the PVACL melt after its neutralization and directly after its production by acid-catalyzed acetalization of PVA with starch or starch derivatives in the reaction extruder, such as a two-screw extruder, whereby a concentration of the destructuring agent is to be adjusted between 0.5 and 10% by weight, preferably between 0.5 and 5% in the PVACL mixture.

As an alternative, the destructuring agents, thus the combination system components (2), can be introduced in their improved manageability (pumpability) in the production of the packaging systems according to the invention as dilute preparations, i.e., as solutions, emulsions or suspensions in alcohols, glycerol or water or mixtures thereof. In this case, destructuring agent concentrations in such preparations are advantageous that lie between 1-80%, preferably between 10-60%, in water and can be introduced by kneading in the reaction extruder after the neutralization stage up to a total content of the destructuring agent in the PVACL mixture of between 0.1 and 10%.

The destructuring agents as combination-system components (2) can be made available for the production of the packaging systems according to the invention but also by subsequent surface application of the same to the PVACL films that are used for encapsulation, specifically either “as is” or as dilute preparations, i.e., as solutions, emulsions or suspensions in alcohols, glycerol or water or paraffin oil or mixtures thereof. In the latter case, the destructuring agents are used in concentrations of between 1 to 30%, preferably between 2-20%, in water. The application can be carried out by usual application methods, such as spraying, stretching, or spreading out, etc., specifically either directly in the rotary-die process before the films are fed to the heating segment of the encapsulation, or else also already up to 2 hours in advance.

Especially preferred is the direct application in the rotary-die process to the continuous films fed to the heating segment, i.e., directly before the encapsulation, so that it does not result in any adhesive-making partial dissolving-on of the films, which would lead to problems by gluing the films on the heating segment. In the processes that do not correspond to the cold-sealing process according to the invention, a partial evaporation of the dissolved-on agent is produced specifically by the higher temperature on the heating segment that is necessary for the heat-sealing process, and said evaporation results in an effect analogous to the known “Leidenfrost effect” for forming a vapor barrier layer between film and heating segment on which the films have proven to be effective as floating on an air cushion before the adhesion on the heating segment—but with the usual drawbacks known for heat-sealing processes (e.g.: temperature stress, formation of vapor bubbles, etc.).

A special embodiment in the use of the packaging systems according to the invention is the introduction of destructuring agents into the PVACL melts in their production in the extruder and specifically directly after the neutralization of the acetalization catalyst either “as is,” i.e., in untreated form, or as aqueous emulsions, solutions or suspensions, subsequent production of granulates from these melts by strand emulsion, strand cooling and granulation, followed by a film extrusion from such granulates, with the especially preferred embodiment of an additional activation of the destructuring agents by blowing in the films with water vapor, such as saturation vapor, at temperatures of between 100 and 160° C., directly before the supply of these PVACL films to the heating segment in the rotary-die process and subsequent capsule formation as well as sealing.

In a simpler embodiment, however, the destructuring agent or solutions, suspensions or emulsions therefore, can also be sprayed or spread on the films to be connected on the side facing the counterfilm before the sliding of the PVACL films onto the heating segment in the rotary-die process or directly before the sealing process. As vehicles for such destructuring agent solutions, suspensions or emulsions, liquid monovalent or preferably multivalent alcohols, but preferably also water, are suitable at room temperature.

If the destructuring agents are not added or are only partially added into the PVACLs before their granulation but the latter is to take place only after the films were already produced, the destructuring agents can also be sprayed or spread on the side facing the counterfilm directly before the sealing of the films produced therefrom, for example in the rotary-die process before the heating segment, and an especially advantageous process variant is produced if only a little destructuring agent remains bonded inside the PVACL film, but rather the latter virtually is introduced only there where it is consumed. This is achieved in as much as with or without the addition of viscosity reducing agents such as liquid water; it is introduced as a diluent, by action of ultrasound of the destructuring agent before pressing together in the films to be sealed together by ultrasound diffusion. In this case, this ultrasound action does not lead to an ultrasound bonding, since the ultrasound is virtually not absorbed by PVACL films and therefore hardly contributes to a temperature increase.

Especially preferred is the production of the packaging systems according to the invention in the reaction extruder, whereby the PVA raw materials therein are reacted with the starch or starch-derivative raw materials in the presence of the softener proportions to be adjusted according to the invention, i.e., preferably glycerol and water in the presence of phosphoric acid or p-toluenesulfonic acid, at temperatures of between 140 and 160° C. by acetalization. After reaching degrees of reaction of more than 60% of theory—preferably of more than 84% of theory—the reaction mixture is neutralized with triethanolamine. Then, while being cooled, the proportion of destructuring agents—the latter preferably as aqueous emulsions with concentrations that allow it, when using destructuring agent preparations with destructuring agent concentrations of 5 to 10% by weight in the PVACL-final total water contents, measurable according to Karl-Fischer—or preferably measured via the weight loss after 24 hours of drying at 105° C.—is adjusted in a range of 7 to 25% by weight by taking into consideration the evaporation losses in the strand extrusion nozzle and in the granulation.

In contrast to thermoplastic starch, which is produced completely from renewable raw materials, PVACLs, independently of their cold-water solubility, also show the disadvantage that they can be produced by the proportion of polyvinyl alcohol in absolutely standardized form and not, as is the case in pure natural substances, having properties that change from feedstock to feedstock. This is an essential advantage of the process in the case of complex processes, such as the rotary-die process, in which it results in especially high precision of the property parameters to be observed and in which each process disruption or interruption is to be avoided.

In this case, the PVACLs for the process according to the invention or for the packages according to the invention can be supplied both as cast films and as extrusion films to the filling and sealing process. Preferred are extrusion films, i.e., films that are produced according to the usual cast extrusion process by extrusion of PVACL granulate through a sheet die and forming to the desired film thickness over a so-called “chill roll” (cooling roller).

The thickness of the PVACL films, which are fed according to the invention to the filling and sealing zone, must be between 100 and 1000 μm. Film thicknesses of 300-800 μm are preferred.

By the heat-sealing-analogous “cold-seal” connection process according to the invention, the process also the advantage that, surprisingly enough, the sealing at film temperature can be performed far below the usual melting interval and thus the contents can be sealed below the boiling point of water, by which it does not result in the boiling of the film surface during sealing. This boiling produces undesirable bubbles in the sealing seam and thus not only unsightly, cloudy sealing seams but also weak spots in the sealing seam. As a result, according to the process according to the invention, special heat-sensitive contents, such as enzyme-containing detergents, can also be securely packaged without the contents being able to be damaged by high sealing temperatures. Finally, the process according to the invention in the rotary-die process also offers the advantage that capsules that are tightly filled completely with the contents can be produced that are thus tight and dimensionally stable. Therefore, no “watery pouches” are formed in which significant water vapor development from the contents results because of the comparatively high sealing temperatures to be used in other processes. Also, no dissolving-on processes are used in the rotary-die process, in which solvents in the form of large amounts of water are used, such that a film dissolving-on can occur, whereby, however, the water vapor expands the packing during sealing but after its condensation after the cooling to the service temperature, the volume that is thereby occupied during sealing remains as empty space. Packings are thus made available that are never full but rather contain “bubbles,” i.e., empty space.

The invention is explained in more detail by the examples below and based on the depictions of FIGS. 1 to 4, whereby FIG. 1 shows a bag (pouch) with defects according to the prior art, FIGS. 2 and 3 show device units for a rotary-die process, and FIG. 4 shows the G′/G″-ω-relaxation diagram for gelatin and PVACL.

### COMPARISON EXAMPLE 1

In the rotary-die process—as shown in FIG. 2—an approximately 500 μm-thick gelatin film 11, 11′ was fed to the two section rollers 6, 7 directly from one flat film extruder each. In one sample of this gelatin film, a crossover point (one-point) at ω=5 s⁻¹ was found in a separate test at 35° C. in the universal rheometer of the Paar-Physics Company with a plate-plate-measuring system in the oscillation mode in the storage modulus (G′)-/loss model (G″)-angular frequency diagram, which shows that in this case, this is a “suitable,” i.e., a suitable polymer in terms of WO-A-97/35 537.

A standard bath oil was used as contents 10.

The supply segment 9 was heated to 42° C., by which the films were heated to a surface temperature of 40° C. before filling (IR pyrometric remote measurement).

After pressing together the two films on the lower end of the drum, satisfactory, tight, bubble-free filled capsules 12 were immediately obtained, which, however, since the encapsulation material was gelatin, dissolve only in hot water, but remain undissolved in cold water.

### COMPARISON EXAMPLE 2

In the rotary-die process—as shown in FIG. 2—an approximately 500 μm-thick PVA film 11, 11′ was fed to the two section rollers 6, 7 directly from one flat film extruder each, and said film was produced from MOWIOL® 18-88 of the company Kuraray Specialities Europe GmbH (Frankfurt, Germany). The latter was “preblended” (premixed) to achieve a plastic state, whereby the procedure was the same according to the manufacturer information with a mixture that consists of glycerol and water (10% glycerol+4% water on PVAL) (melting point or softening point around 160° C.; crossover point (one-point) measured in the universal rheometer of the Paar-Physics Company with plate-plate measuring system in the oscillation mode in the storage modulus (G′)-/loss modulus (G″)-angular frequency diagram at ω=200 s⁻¹). A standard bath oil was used as contents 10.

The supply segment 9 was adjusted to a temperature of 170° C., by which the films 11, 11′ were heated to a mean temperature of 155° C. before filling (IR pyrometric remote measurement).

After the pressing together of the two films on the ridges of the bowls 8 on the lower end of the section rollers, however, no tight capsules were obtained, but rather the punched-out capsules 12 immediately fragmented into two parts and were delivered.

Also, another increase of the supply-segment temperature to 180° C. did not produce any stable capsules; for this purpose, the contents 10 began to boil when pressing into the capsule forms.

### COMPARISON EXAMPLE 3

The rotary-die encapsulation test is performed as in Comparison Example 2 (heating segment adjusted to 170° C., PVA film temperature 155° C.), but with the difference that according to the recommendations from WO-A-97/35 537, the heat-sealing process was performed after the application of large amounts of water on the surface of at least one of the two films 11, 11,′ and the thus pretreated film had to rest for about 5 minutes with a wet surface so that this film thus was truly dissolved-on.

Immediately after the capsules fell out under section rollers, sealed capsules were obtained, but the latter began to leak after a few hours of storage and later fragmented again into two halves even with low mechanical stress. A microscopic study of the sealing edges showed that the latter never truly bond but rather only adhere and therefore were connected reversibly only for a short time, i.e., so-called “weak seals” were present. These packaging forms correspond to those according to FIG. 1, which show defects 3 in the sealing edges 2. Air can also penetrate through these defects during packing, so that air bubbles 4 and thus dimensionally stable packing 1 are produced.

### EXAMPLE 1

In the rotary-die process—as shown in FIG. 2—an approximately 600 μm thick PVACL film 11, 11′ was fed directly from one flat film extruder each to the two section rollers 6, 7.

A melt interval of 151-166° C. was determined in separate tests by means of DTA (differential thermoanalysis) in a sample of this PVACL film in the normal state, and no crossover point was found in the universal rheometer of the Paar-Physics Company with plate-plate-measuring system in the oscillation mode at 140° C. in the storage modulus (G′)-/loss modulus (G″)-angular frequency diagram. The measurement of the relaxation enthalpy, after the film was sprayed with a 3% by weight emulsion that consists of GUERBET alcohol (Stenol®) in water and was allowed to rest for 5 seconds, produced a maximum of the relaxation enthalpy at 0.11 s in the relaxation-enthalpy-relaxation-time diagram.

The material is an acetal that had been produced by acid-catalyzed reaction of 60 parts by weight of a mixture that consists of one part of the polyvinyl alcohol MOWIOL® 4-88 and 3 parts of MOWIOL® 8-88 of the company KSE Kuraray Specialties Europe GmbH (Frankfurt, Germany) with 40 parts by weight of native potato starch, whereby the potato starch was softened with 13 parts by weight of glycerol and 4 parts by weight of water, both relative to 100 parts by weight of the previously-mentioned sum of the PVA and starch weights.

These data corresponded to a total water content according to Karl-Fischer of 7.2% relative to the total PVACL.

A standard bath oil was used as contents 10.

The heating segment 9 was heated to 170° C., by which the film reached a mean temperature of 135° C. before the filling and cooled on the surface to 125° C. (IR pyrometric remote measurement) by the filling with the contents heated only to 70° C. for the care of the contents. That is to say, a sealing under these conditions corresponds to a “cold-sealing process” according to the invention. Directly before the heating segment 9, an emulsion of 2% GUERBET alcohol in water was sprayed in two films on the side facing the counterfilm (dwell time until contact and sealing about 3 seconds).

After the two films are pressed together on the lower end of the drum, satisfactory, tight, bubble-free filled capsules 12 were immediately obtained.

After several days of storage time, the capsules also proved to be stable and soluble in cold (20° C.) water.

In the mod. Sturm Test (OECD 301B), the capsule material was mineralized within 28 days to more than 72% (TOC), whereby it is usual, according to the expertise of the EMPA (Federal Material Examination Station), to refer to substances as slightly biodegradable if, after 28 days of contact with activated sludge, at least 60% of the carbon has been converted into carbon dioxide in this test.

### COMPARISON EXAMPLE 4

With the same PVACL material as in Example 1 (spreading with water as a solvent), the encapsulation test from Example 1 was repeated, but with the omission of the destructuring agent.

Directly after capsules fell out under the section rollers, sealed capsules were again obtained as in Comparison Example 3, but the latter began to leak after a few hours of storage and later fragmented again into two halves even with low mechanical stress. A microscopic study of the sealing edges showed that the latter were not truly bonded, but rather only glued and therefore connected reversibly only for a short time, i.e., again only so-called “weak seals,” i.e., defects 3, as shown in FIG. 1, were obtained.

### EXAMPLE 2

In the rotary-die process according to FIG. 3, an approximately 500 μm thick PVACL film 11, 11′ was fed directly to the two section rollers 6, 7 from one flat film extruder each. The material again is an acetal from 60% by weight of MOWIOL® 8-88 of the company KSE Kuraray Specialties Europe GmbH Company (Frankfurt, Germany) and 40% by weight of native potato starch, which was softened with 13 parts by weight of glycerol and 12 parts by weight of water, both related to 100 parts by weight of the sum of the weights of PVAL and starch. (These data corresponded to a total water content according to Karl-Fischer of 15%).

In the PVACL material, even in the strand extrusion for the production of the PVACL granulate, 5% by weight of monovalent GUERBET alcohol (Stenol®) was kneaded. The use of this granulate for film extrusion directly followed by supply to the section rollers in the rotary-die process without further wetting again yielded satisfactory, long-term stable capsules.

Also, stable capsules were obtained when the extrusion films that consist of this material before reaching the section rollers in the rotary-die process with water vapor (saturation vapor) of 120° C. were blown in. These capsules were only somewhat softer than those that were produced without vapor blowing. By forming the bowls 8, according to this embodiment of the invention, an “elephant's foot sealing seam”—see FIG. 3a—could be produced.

In summary, it can be said that in contrast to the known processes, the process according to the invention does not produce any heat-sealing process but rather produces a cold-sealing process, in which, nevertheless, a satisfactory sealing adhesion between the film webs is produced. This effect is based on the fact that the special properties of the film starting materials, namely the PVACL films, are used in combination with destructuring agents. These destructuring agents cause the hydrogen bonds between the polymer chains to be at least partially broken, so that without additional additives, a cohesive connection is made available in a cold-sealing process. This has the advantage that heat-sensitive contents, such as detergents or pharmaceutical preparations with temperature-sensitive active ingredients, can also be packaged within the scope of the process according to the invention, i.e., the cold-sealing process, with no further temperature application required. Nevertheless—produced by the true bonding in the sealing seam area—a satisfactory sealing seam strength is provided, so that the sensitive contents are protected from penetration of contaminants or humidity and, primarily even in the case of common stress, the packing remains tight against varying temperatures during extended storage.

### LEGEND

1 Pouch (bag) according to the prior art
2 Extracapsular sealing seam
3 Defects (degree of capillary leakage)
4 Air bubble
5 Device for rotary-die process
6, 7 Section rollers
8 Bowl
9 Supply segment (heating segment)
10 Contents
11, 11′ Film or counter-film
12 Capsule
13 Elephant's foot sealing seam

1-18. (canceled)

19. Process for the production of packaging material systems for technical and pharmaceutical single portions with use of (1) vinyl alcohol copolymers (PVACL), produced by the acid-catalyzed acetalization reaction of polyvinyl alcohol with starch or starch derivatives, in combination with (2) destructuring agents, characterized in that cold-water-soluble, aqueous, vinyl alcohol copolymers (PVACL) are selected from a group that show no crossover point (one-point) in their normal state in the storage modulus (G′)-/loss modulus (G″)-angular frequency diagram in the range between 0.1 and 1000 s⁻¹, but have a relaxation enthalpy maximum in relaxation times under 2 seconds in the presence of the destructuring agent in the relaxation enthalpy-relaxation time diagram, and in that these selected vinyl alcohol copolymers are produced before or after from these films and are replaced by destructuring agents, such that the hydrogen bridges between the polymer chains are completely or at least partially broken up, and in that then the thus prepared films from vinyl alcohol copolymers are heated to temperatures below their melting or softening interval, whereby these temperatures according to the invention are at an interval of at least 5° C. below the melting or softening point that can be determined by means of DSC, and in that these heated films are further processed in a cold-sealing process, using pressure to produce sealing seams in packages in the form of single portions.

20. Process according to claim 19, wherein the surface temperature of the films that are to be connected at the time of the pressing together for sealing as well as at the sealing seam to be produced and also during the filling with the contents is in a range of between 5 to 20° C., preferably 5 to 10° C., below the melting or softening point that can be determined by means of DSC.

21. Process according to claim 19, wherein as vinyl alcohol copolymers (PVACL), those are used that were produced by acid-catalyzed acetalization of 70 to 35 parts by weight of PVA with 30 to 65 parts by weight of starch or starch derivatives.

22. Process according to claim 19, wherein as vinyl alcohol copolymers (PVACL), those are used that were produced by acid-catalyzed acetalization of 65 to 55 parts by weight of PVA with 35 to 45 parts by weight of starch or starch derivatives.

23. Process according to claim 19, wherein the vinyl alcohol components of the polyvinyl alcohol copolymer mixtures that are used are of various PVA types, which have a mean molecular weight (weight average) of between 25,000 and 130,000, preferably between 30,000 and 70,000.

24. Process according to claim 23, wherein the polyvinyl alcohol components of the vinyl alcohol copolymers that are used can be produced by partial saponification of polyvinyl acetate up to a degree of saponification of between 80 and 92 mol %, preferably between 85 and 90 mol %.

25. Process according to claim 19, wherein the starch component of the vinyl alcohol copolymers that are used is selected from the group of corn, rice or tapioca starch.

26. Process according to claim 19, wherein the starch component that is used in the vinyl alcohol copolymers that are used has a mean molecular weight (weight average) of between 50,000 and 500,000, preferably between 150,000 and 300,000, that is reduced by oxidative degradation.

27. Process according to claim 19, wherein the starch component that is used in the vinyl alcohol copolymers that are used has a mean molecular weight (weight average) of between 50,000 and 500,000, preferably between 150,000 and 300,000, that is reduced by oxidative degradation and in addition is ethoxylated or propoxylated up to 15 mol % (relative to the C₈ units)

28. Process according to claim 19, wherein the destructuring agent that is used is selected from the group of montanic acids, montanic acid ester, anionic and/or non-ionic surfactants, oxidized, preferably low-molecular polyethylene, monovalent branched C₁₀- to C₁₆-alcohols, ethoxylation products of monovalent branched C₁₀-C₁₆-alcohols with a degree of ethoxylation of 5-20.

29. Process according to claim 19, wherein the destructuring agent that is used is selected from the group of GUERBET alcohols.

30. Process according to claim 19, wherein the destructuring agents are added to the vinyl alcohol copolymers before the film production and then these films are further processed in a sealing process, preferably in a rotary-die process.

31. Process according to claim 19, wherein the destructuring agent is fed to the vinyl alcohol copolymers in the form of solutions, emulsions or suspensions, then films are extruded therefrom and are further processed in a sealing process, preferably in a rotary-die process.

32. Process according to claim 19, wherein both the destructuring agent and the vinyl alcohol copolymers are melted, these melts are further processed into films and then are further processed in a sealing process, preferably a rotary-die process.

33. Process according to claim 19, wherein the destructuring agent is sprayed or spread directly before the sealing process on the vinyl alcohol copolymers that are present in the form of films, and the thus pretreated film is then combined with the respective counter-film in the sealing process.

34. Process according to claim 19, wherein the destructuring agent is fed to the vinyl alcohol copolymers in the form of solutions, emulsions or suspensions, then films are extruded therefrom and are further processed in a sealing process, preferably in a rotary-die process, and
wherein the destructuring agent that is introduced into the PVACL mass is activated directly before the sealing process by blowing in the film with water vapor, and the thus pretreated film then is combined with the respective counter-film in the sealing process.

35. Process according to claim 19, wherein the vinyl alcohol copolymer that is used is produced in a reaction extruder by acid-catalyzed acetalization reaction of polyvinyl alcohol as well as mixtures therefrom with starch or starch derivatives.

36. Use of a packaging material system, produced according to claim 19, for packaging technical and/or pharmaceutical substances in the form of single portions.

37. Process according to claim 20, wherein as vinyl alcohol copolymers (PVACL), those are used that were produced by acid-catalyzed acetalization of 70 to 35 parts by weight of PVA with 30 to 65 parts by weight of starch or starch derivatives.

38. Process according to claim 20, wherein as vinyl alcohol copolymers (PVACL), those are used that were produced by acid-catalyzed acetalization of 65 to 55 parts by weight of PVA with 35 to 45 parts by weight of starch or starch derivatives.
